(19) United States
(12) Patent Application Publication
(10) Pub. No.: US 2024/0273289 A1
(43) Pub. Date: Aug. 15, 2024

(54) FRAMEWORK FOR MULTI-INPUT, MULTI-OUTPUT GRAPH NEURAL NETWORKS FOR HETEROGENEOUS GRAPHS

(71) Applicant: Publicis Groupe SA, Paris (FR)

(72) Inventors: Yingbo Li, Paris (FR); Raj Neel Shah, London (GB); Theodore Barbar Khoury, Dubai (AE); Ali Nehme, Dubai (AE)

(21) Appl. No.: 18/110,004

(22) Filed: Feb. 15, 2023

(51) Int. Cl. G06F 40/279; G06F 40/40; G06N 3/04; G06N 3/08

(52) U.S. Cl. CPC G06F 40/279; G06F 40/40; G06N 3/04; G06N 3/08; G06F 40/30

(57) ABSTRACT

A framework for multi-input, multi-output graph neural networks for heterogeneous graphs is disclosed. Processor(s) build a heterogeneous graph that includes document nodes in a first coordinate space and keyword nodes in a second coordinate space. The processor(s) transform the heterogeneous graph into a transformed graph in which the document nodes and the keyword nodes are in the shared coordinate space and separate the transformed graph into a first transformed sub-graph and a second transformed sub-graph in the shared coordinate space. The processor(s) feed the first transformed sub-graph and the second transformed sub-graph to the graph neural network and obtain document embeddings and keyword embeddings in the shared coordinate space to enable the document embeddings and the keyword embeddings to be compared directly to each other. The processor(s) generate the keyword recommendations for the text corpus based on similarity scores determined by comparing the embeddings.

### TECHNICAL FIELD

The present disclosure generally relates to graph neural networks and, more specifically, to a framework for multi-input, multi-output graph neural networks for heterogeneous graphs.

### BACKGROUND

Recently, knowledge graphs have been used to represent relationships between pieces of information in the form of a semantic graph. A knowledge graph includes nodes that represent pieces of information and edges that represent relationships between those pieces of information. A homogeneous graph is the simplest type of knowledge graph with only one type of node and one type of edge. A heterogeneous graph is a knowledge graph with two or more types of nodes and/or two or more types of edges. For instance, a heterogeneous graph with two node types and one edge type is a bipartite graph. A heterogeneous graph with one node type and two or more edge types is a multi-dimensional graph. Recently, graph neural networks (GNNs), a type of artificial neural network, have been used to process information of knowledge graphs.

Homogeneous GNNs, such as GraphSAGE, are designed to process information of homogeneous graphs. Because homogeneous graphs include only one type of node and one type of edge, homogeneous GNNs are able to compute embeddings for all of the nodes of the graph in the same coordinate space. In turn, homogeneous GNNs may be relatively computationally efficient. However, due to the complexity of the real world, many knowledge graphs representing real-world scenarios are not homogeneous graphs, thereby limiting the application of homogeneous GNNs.

Heterogeneous GNNs are designed to process information of a heterogeneous graphs. Because of the complexity of information represented by heterogeneous graphs, many heterogeneous GNNs, such as PinSage, are limited to processing bipartite graphs (the simplest form of heterogeneous graphs). Additionally, heterogeneous GNNs typically generate embeddings for the different node types in different coordinate spaces. As a result, the embeddings of the different node types cannot be compared directly with each other, without corrupting the embedding accuracy or significantly increasing the computational speeds, since the nodes are not represented in the same coordinate space.

Applications of GNNs and other of artificial neural networks have been explored in a number of different industries, such as social networks, biology, drug discovery, image recognition, and text processing. For instance, GNNs and knowledge graphs have been used by recommendation systems for information retrieval engines, such as search engines. One type of recommendation system is a knowledge-based filtering system, which may use relationships in knowledge graphs to provide recommendations for a query. In some instances, such systems have been used for providing keyword recommendations.

Existing keyword recommendation systems typically process each individual document individually or regard multiple text documents as a whole, thereby ignoring any individual characteristic of a particular document or any relationship between documents. While such a localized approach considers features of documents containing a keyword, such an approach does not account for relationships between the documents or features of other words within the same batch of documents.

### SUMMARY

The appended claims define this application. The present document discloses aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for a graph neural network framework for heterogeneous graphs. An example system for providing keyword recommendations for a text corpus is disclosed herein. The system includes memory configured to store a graph neural network that is trained to embed multiple node types of a heterogeneous graph in a shared coordinate space. The system includes one or more processors that are configured to obtain the text corpus that includes documents and generate keywords for the text corpus, at least in part, by extracting extracted keywords from the documents. The one or more processors are configured to build the heterogeneous graph to include nodes and edges. The nodes include document nodes each of which represents a respective one of the documents in a first coordinate space associated with document features. The nodes include keyword nodes each of which represents a respective one of the keywords in a second coordinate space associated with keyword features. The edges extend between the nodes to represent relationships between the documents and the keywords. The one or more processors are configured to transform the heterogeneous graph into a transformed graph in which the document nodes and the keyword nodes are in the shared coordinate space. The one or more processors are configured to separate the transformed graph into a first transformed sub-graph that includes the document nodes without the keyword nodes in the shared coordinate space and a second transformed sub-graph that includes the keyword nodes without the document nodes in the shared coordinate space. The one or more processors are configured to feed the first transformed sub-graph and the second transformed sub-graph to the graph neural network. The one or more processors are configured to obtain an embedding matrix from the graph neural network that includes document embeddings for the document nodes and keyword embeddings for the keyword nodes in the shared coordinate space to enable the document embeddings and the keyword embeddings to be compared directly to each other. The one or more processors are configured to determine similarity scores among the nodes based on comparisons between the document embeddings and the keyword embeddings and generate the keyword recommendations for the text corpus based on the similarity scores.

In some examples, to transform the heterogeneous graph into the transformed graph, the one or more processors are configured to normalize and merge together a first matrix representing the document nodes and a second matrix representing the document nodes in the shared coordinate space.

In some examples, the one or more processors are configured to feed the first transformed sub-graph and the second transformed sub-graph to the graph neural network simultaneously as separate inputs.

In some examples, the one or more processors are configured to determine the similarity scores using cosine similarity.

Some examples further include an embeddings database in which the one or more processors are configured to store the similarity scores for the documents and the keywords of the text corpus.

In some examples, to generate the keyword recommendations for the text corpus, the one or more processors are configured to select one or more of the keywords for each of the documents in the text corpus.

In some examples, to generate the keyword recommendations for the text corpus, the one or more processors are configured to select up to a predefined number of greatest-scoring keywords.

In some examples, the keywords include the extracted keywords and extended keywords. To generate the keywords for the text corpus, the one or more processors are further configured to collect extended text for the text corpus by querying at least one of a social media or a search engine using the extracted keywords and extract the extended keywords from the extended text.

In some examples, the keywords include the extracted keywords and extended keywords. To generate the keywords for the text corpus, the one or more processors are further configured to collect the extended keywords by using a search engine to query for additional keyword suggestions for the extracted keywords.

Some examples further include a training database that is configured to store a training sample. The one or more processors are configured to train the graph neural network using the training sample. In some such examples, the training sample is a heterogeneous graph sample. The one or more processors are configured to transform the heterogeneous graph sample into a transformed training graph and separate the transformed training graph into a first training sub-graph and a second training sub-graph.

In some examples, to train the graph neural network, the one or more processors are configured to use weighted random walk and double forward propagations.

An example method for providing keyword recommendations for a text corpus is disclosed. The method includes obtaining, via one or more processors, the text corpus that includes documents. The method includes generating, via the one or more processors, keywords for the text corpus, at least in part, by extracting extracted keywords from the documents. The method includes building, via the one or more processors, a heterogeneous graph to include nodes and edges. The nodes include document nodes each of which represents a respective one of the documents in a first coordinate space associated with document features. The nodes include keyword nodes each of which represents a respective one of the keywords in a second coordinate space associated with keyword features. The edges extend between the nodes to represent relationships between the documents and the keywords. The method includes transforming, via the one or more processors, the heterogeneous graph into a transformed graph in which the document nodes and the keyword nodes are in a shared coordinate space. The method includes separating, via the one or more processors, the transformed graph into a first transformed sub-graph that includes the document nodes without the keyword nodes in the shared coordinate space and a second transformed sub-graph that includes the keyword nodes without the document nodes in the shared coordinate space. The method includes feeding, via the one or more processors, the first transformed sub-graph and the second transformed sub-graph to a graph neural network that is trained to embed multiple node types of the heterogeneous graph in the shared coordinate space. The method includes obtaining, via the one or more processors, an embedding matrix from the graph neural network that includes document embeddings for the document nodes and keyword embeddings for the keyword nodes in the shared coordinate space to enable the document embeddings and the keyword embeddings to be compared directly to each other. The method includes determining, via the one or more processors, similarity scores among the nodes based on comparisons between the document embeddings and the keyword embeddings and generating, via the one or more processors, the keyword recommendations for the text corpus based on the similarity scores.

Some examples further include training the graph neural network using a training sample stored in a training database.

In some examples, generating the keywords for the text corpus further includes identifying first extended keywords by collecting extended text for the text corpus by querying at least one of a social media or a search engine using the extracted keywords and extracting the first extended keywords from the extended text. Generating the keywords for the text corpus further includes identifying second extended keywords by using a search engine to query for additional keyword suggestions for the extracted keywords.

An example computer readable medium including instructions is disclosed. The instructions, which, when executed, cause a machine to obtain a text corpus that includes documents and generate keywords for the text corpus, at least in part, by extracting extracted keywords from the documents. The instructions cause the machine to build a heterogeneous graph to include nodes and edges. The nodes include document nodes each of which represents a respective one of the documents in a first coordinate space associated with document features. The nodes include keyword nodes each of which represents a respective one of the keywords in a second coordinate space associated with keyword features. The edges extend between the nodes to represent relationships between the documents and the keywords. The instructions cause the machine to transform the heterogeneous graph into a transformed graph in which the document nodes and the keyword nodes are in a shared coordinate space. The instructions cause the machine to separate the transformed graph into a first transformed sub-graph that includes the document nodes without the keyword nodes in the shared coordinate space and a second transformed sub-graph that includes the keyword nodes without the document nodes in the shared coordinate space. The instructions cause the machine to feed the first transformed sub-graph and the second transformed sub-graph to a graph neural network that is trained to embed multiple node types of the heterogeneous graph in the shared coordinate space. The instructions cause the machine to obtain an embedding matrix from the graph neural network that includes document embeddings for the document nodes and keyword embeddings for the keyword nodes in the shared coordinate space to enable the document embeddings and the keyword embeddings to be compared directly to each other. The instructions cause the machine to determine similarity scores among the nodes based on comparisons between the document embeddings and the keyword embeddings and generate keyword recommendations for the text corpus based on the similarity scores.

In some examples, the instructions further cause the machine to train the graph neural network using a training sample stored in a training database. The training sample is a heterogeneous graph sample. In some such examples, the instructions further cause the machine to transform the heterogeneous graph sample into a transformed training graph and separate the transformed training graph into a first training sub-graph and a second training sub-graph.

In some examples, to train the graph neural network, the instructions further cause the machine to use weighted random walk and double forward propagations.

In some examples, to generate the keywords for the text corpus, the instructions further cause the machine to identify first extended keywords and second extended keywords. To identify the first extended keywords, the instructions further cause the machine to collect extended text for the text corpus by querying at least one of a social media or a search engine using the extracted keywords and extract the first extended keywords from the extended text. To identify the second extended keywords, the instructions further cause the machine to use a search engine to query for additional keyword suggestions for the extracted keywords.

An example system for framing a heterogeneous graph for use with a graph neural network is disclosed. The system includes memory configured to store the graph neural network that is trained to simultaneously analyze multiple node types of the heterogeneous graph. The system includes one or more processors configured to obtain the heterogeneous graph that includes nodes of a plurality of node types and edges. Each of the plurality of node types has a unique coordinate space for the respective nodes. The edges extend and represent relationships between the nodes. The one or more processors are configured to transform the heterogeneous graph into a transformed graph such that the nodes of all of the plurality of node types are in a shared coordinate space. The one or more processors are configured to separate the transformed graph into a plurality of transformed sub-graphs. Each of the plurality of transformed sub-graphs includes only the nodes of a respective one of the plurality of node types in the shared coordinate space. The one or more processors are configured to simultaneously feed each of the plurality of transformed sub-graphs to the graph neural network.

In some examples, the one or more processors are further configured to obtain a plurality of vectors from the graph neural network. Each of the plurality of vectors includes embeddings for a respective one of the plurality of node types. The embeddings of each of the plurality of vectors are in the shared coordinate space to enable direct comparisons between the embeddings for the plurality of node types. In some such examples, the one or more processors are further configured to determine similarity scores among the nodes based on comparisons between the embeddings of the plurality of vectors and generate recommendations based on the similarity scores. Further, in some such examples, the one or more processors are configured to determine the similarity scores using cosine similarity. Further, some such examples further include an embeddings database in which the one or more processors are configured to store the similarity scores.

In some examples, the one or more processors are configured to obtain at least one of cross-node clustering or classifications by feeding the plurality of transformed sub-graphs to the graph neural network.

In some examples, to transform the heterogeneous graph into the transformed graph, the one or more processors are configured to normalize and merge together matrices for the plurality of node types in the shared coordinate space. Each of the matrices corresponds with a respective one of the plurality of node types.

In some examples, the one or more processors are configured to feed the plurality of transformed sub-graphs simultaneously as separate inputs.

Some examples further include a training database that is configured to store a training sample. The one or more processors are configured to train the graph neural network using the training sample. In some such examples, the training sample is a heterogeneous graph sample. The one or more processors are configured to transform the heterogeneous graph sample into a transformed training graph and separate the transformed training graph into a plurality of training sub-graphs.

In some examples, to train the graph neural network, the one or more processors are configured to use weighted random walk and double forward propagations.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 is a block diagram of system hardware for operating an example graph neural network framework for heterogeneous graphs in accordance with the teachings herein.

FIG. 2 is an example flowchart for using the framework to train a graph neural network in accordance with the teachings herein.

FIG. 3 depicts a portion of an example heterogeneous graph.

FIG. 4 depicts a transformation of the portion of the heterogeneous graph of FIG. 3 into a shared coordinate space.

FIG. 5 depicts a detached portion of the transformed heterogeneous graph of FIG. 4.

FIG. 6 depicts another detached portion of the transformed heterogeneous graph of FIG. 4.

FIG. 7 depicts the heterogeneous graph of FIG. 3 with weighted edges.

FIG. 8 depicts an example training process for training a graph neural network in accordance with the teachings herein.

FIG. 9 is an example flowchart for using the framework to feed a heterogeneous graph to a trained graph neural network in accordance with the teachings herein.

FIG. 10 is an example flowchart for using the framework to train a keyword-document graph neural network in accordance with the teachings herein.

FIG. 11 depicts a portion of an example keyword-document graph representing relationships between keywords and documents of a text corpus in accordance with the teachings herein.

FIG. 12 depicts a transformation of the portion of the keyword-document graph of FIG. 11 into a shared coordinate space.

FIG. 13 depicts a detached portion of the transformed keyword-document graph of FIG. 12.

FIG. 14 depicts another detached portion of the transformed keyword-document graph of FIG. 12.

FIG. 15 is an example flowchart for providing keyword recommendations for documents of a text corpus using the framework and a trained keyword-document graph neural network in accordance with the teachings herein.

FIG. 16 depicts a process for generating keyword recommendations for documents of a text corpus using the framework and a trained keyword-document graph neural network.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Example systems and methods disclosed herein include a framework that enables a graph neural network (GNN) to directly compare embeddings of different node types of a heterogeneous graph. Each node type in a heterogeneous graph is represented in a different coordinate space, thereby making it difficult to compare the different node types. The framework disclosed herein facilitates comparisons between different types of nodes by transforming a heterogeneous graph into a homogeneous-like graph in which all node types are mapped in a shared coordinate space. For example, the framework enables a heterogeneous GNN to facilitate a direct comparison between a first node type (e.g., a node representing a document) and a second node type (e.g., a node representing a keyword). Accordingly, the framework disclosed herein is necessarily rooted in graph neural network technology in order to overcome a problem specifically arising in the realm of heterogeneous graph neural networks. By enabling nodes of different types within a heterogeneous graph to be compared directly with each other (e.g., for keyword and/or other recommendation systems), the framework disclosed herein provides an improvement in the computer-related technology of heterogeneous graph neural networks.

To train a heterogeneous GNN within the framework disclosed herein, a heterogeneous training graph is pre-processed. The pre-processing steps include (1) transforming the heterogeneous training graph into a homogeneous-like graph in which all node types are mapped in a shared coordinate space and (2) separating the transformed graph such that each node type has a respective sub-graph. Each sub-graph is used as an input simultaneously with the other sub-graphs during every epoch of training the heterogeneous GNN. The framework enables heterogeneous GNNs, to be trained to simultaneously take multiple inputs (e.g., sub-graphs) and subsequently simultaneously produce multiple outputs (e.g., embedding vectors). In some examples, the multi-input, multi-output heterogeneous GNN is trained using a weighted random walk algorithm and a double forward propagation algorithm.

To use a trained heterogeneous GNN on a heterogeneous graph within the framework disclosed herein, the heterogeneous graph is initially pre-processed by (1) transforming the heterogeneous graph into a homogeneous-like graph in which all node types are mapped in a shared coordinate space and (2) separating the transformed graph such that each node type has a respective sub-graph. The multiple sub-graphs are fed to the trained heterogeneous GNN simultaneously as separate inputs. In some examples, the framework is configured to enable a trained heterogeneous GNN to generate cross-node clustering and classifications. In other examples, the framework is configured to enable a trained heterogeneous GNN to produce one or more matrices (e.g., a vector for each node type), which include multiple sets of embeddings with a first set of embeddings for nodes of a first node type and a second set of embeddings for nodes of a second node type.

Each of the embeddings are in the same shared coordinate space to enable the different types of nodes to be compared directly to each other without additional complex analysis. That is, the framework generates end-to-end embedding of heterogeneous graph nodes in a shared coordinate space in order to enable cross-node similarity comparisons for recommendations in a manner that avoids corrupting the embedding accuracy. Additionally, unlike existing heterogeneous models such as PinSage, the end-to-end embedding of the nodes in the shared coordinate space significantly reduces computational speeds by not requiring separate runs of the GNN for each node type of the heterogeneous graph.

For examples in which the heterogeneous graph represents a text corpus of documents, the trained heterogeneous GNN produces one or more matrices in which document embeddings and keyword embeddings are in the same coordinate space. Similarity scores are then determined among the nodes (e.g., using cosine similarity) without requiring a large amount of additional processing. The keyword recommendations are then generated for the text corpus based on a ranking of the similarity scores. In turn, the framework enables the trained heterogeneous GNN to be used in a global approach that considers not only statistical and semantic features of documents containing a keyword but also relationships between documents and features of other words within the text corpus. That is, the framework does not take a localized approach in which features of only those documents that contain a particular keyword are considered, but, instead, takes a global approach in which (1) relationships between documents and (2) features of words in other documents of the text corpus are considered.

As used herein, a “knowledge graph” refers to a graph-structured data model. Knowledge graphs include nodes and edges. As used herein, a “node” of a GNN refers to a data object of a knowledge graph that represents an object (e.g., a person, a place, a thing, etc.) in a coordinate space. As used herein, an “edge” of a GNN refers to a feature of a knowledge graph that represents a relationship between two nodes in a coordinate space. As used herein a “shared coordinate space” refers to a coordinate space in which multiple node types and edges of a heterogeneous graph are represented.

As used herein, a “heterogeneous graph” and a “multipartite heterogeneous graph” refer to a knowledge graph with two or more types of nodes and/or two or more types of edges. As used herein, a “bipartite graph” and a “bipartite heterogeneous graph” refer to a heterogeneous graph with two node types and one edge type. As used herein, a “homogeneous graph” refers to a knowledge graph with only one type of node and one type of edge.

As used herein, a “graph neural network” and a “GNN” refer to a type of artificial neural network that is configured to analyze features of a knowledge graph. As used herein, a “heterogeneous graph neural network” and a “heterogeneous GNN” refer to a graph neural network that is configured to analyze features of a heterogeneous graph. As used herein, a “bipartite graph neural network” and a “bipartite GNN” refer to a graph neural network that is configured to analyze features of a bipartite graph.

Example graph neural networks may embed knowledge graphs with information associated with the analyzed features. As used herein, to “embed” refers to the process of mapping (e.g., numerically) information associated with feature(s) of node(s) and/or edge(s) of a knowledge graph. As used herein, an “embedding” refers to a representation (e.g., a numerical representation) of information associated with feature(s) of node(s) and/or edge(s) of a knowledge graph. Example graph neural networks may generate one or more embeddings as output(s) to numerically represent the information associated with the analyzed features. Example embeddings may be in the form of a matrix and/or a plurality of vectors.

As used herein, a “text corpus” and a “corpus” refer to a collection of texts and/or documents. Information within an example text corpus may be searched using keywords. As used herein, a “keyword” refers to a word or phrase that is indicative of content within a document and/or a text corpus. As used herein, example keywords may be in the form of a single word or in the form of a phrase (i.e., a string of two or more words).

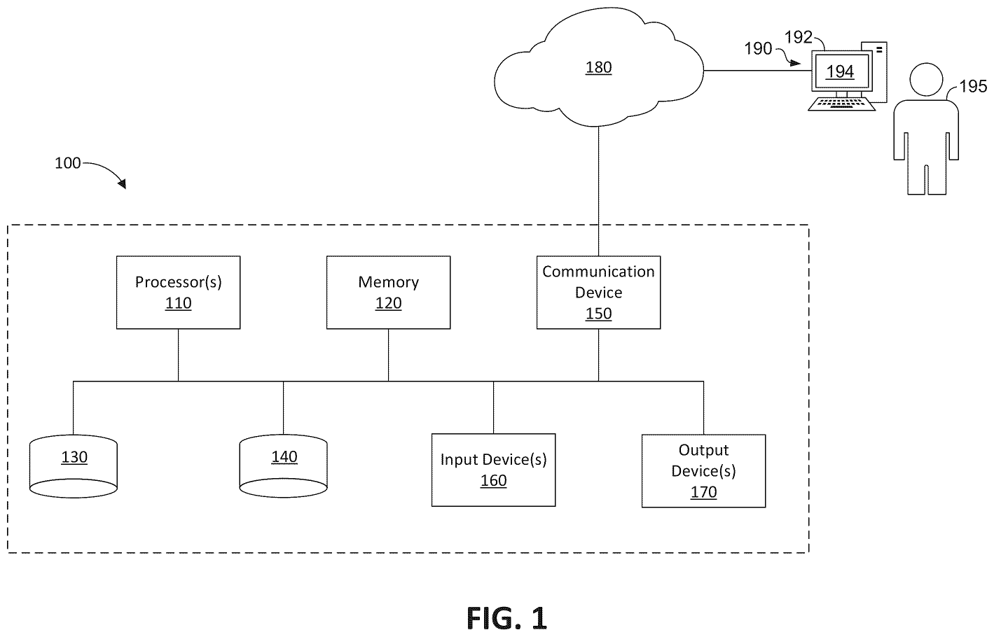

Turning to the figures, FIG. 1 illustrates hardware of an example system 100 for operating an example graph neural network (GNN) framework for heterogeneous graphs. The system 100 includes one or more processors 110, memory 120, a training database 130, an embeddings database 140, a communication module 150, one or more input devices 160, and one or more output devices 170.

The processor(s) 110 includes any suitable processing device or set of processing devices such as, but not limited to, a microprocessor, a microcontroller-based platform, an integrated circuit, etc. In some examples, the memory 120 includes volatile memory (e.g., RAM), non-volatile memory (e.g., disk memory, FLASH memory, etc.), unalterable memory, read-only memory, and/or high-capacity storage devices (e.g., hard drives, solid state drives, etc.). In some examples, the memory 120 includes multiple kinds of memory, such as volatile memory and non-volatile memory.

The memory 120 is computer readable media on which one or more sets of instructions, such as the software for operating at least some of the methods of the present disclosure, can be embedded. The instructions may embody one or more of the methods or logic as described herein. For example, the instructions reside completely, or at least partially, within the memory 120 and/or the processor(s) 110 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

As disclosed below in greater detail, the training database 130 is configured to store a heterogeneous graph test sample that is used to train a heterogeneous GNN. In some examples, the embeddings database 140 is configured to store the one or more matrices and/or vectors that are generated by a trained heterogeneous GNN and include embeddings for the different types of nodes of a heterogeneous graph in a shared coordinate space to enable cross-node comparisons, clustering, classifications, etc. Additionally or alternatively, the embeddings database 140 is configured to store similarity scores and/or recommendations (e.g., keyword recommendations) that are determined based on the one or more embedding matrices and/or vectors.

The communication module 150 is configured to enable communication with a network. 180. As used herein, the term “module” refers to hardware with circuitry configured to perform one or more functions. A “module” may also include firmware that executes on the circuitry to enable the one or more functions to be performed. The network 180 may be a public network, such as the Internet; a private network, such as an intranet; or combinations thereof. The network 180 may utilize a variety of networking protocols. The communication module 150 includes wired or wireless network interfaces to enable communication with the network 180. The communication module 150 also includes hardware (e.g., processors, memory, storage, antenna, etc.) and software to control the wired or wireless network interfaces. For example, the communication module 150 includes hardware, software, and network interfaces for cellular network(s), such as Long-Term Evolution (LTE); wireless local area networks (WLANs), such as Wi-Fi®; wireless personal area networks (WPANs), such as Bluetooth® and/or Bluetooth® Low Energy (BLE); etc.

In the illustrated example, the communication module 150 of the system 100 is configured to communicate with a computer 190 of a user 195. The computer 190 may be a desktop, a laptop, a tablet, a smartphone, a smartwatch, etc. The computer 190 includes a display 192 that is configured to present an interface 194, such as a website (e.g., a web portal), to the user 195. The interface 194 is configured to enable the user 195 to provide input(s) for a GNN of the system 100 and/or to receive output(s) from the GNN of the system 100.

The input device(s) 160 include one or more of a touchscreen, a touchpad, a keyboard, a mouse, a speech recognition system, a button, a control knob, etc. The input device(s) 160 of the illustrated example enable an operator of the system 100 to provide and/or modify instructions and/or data for a GNN, a framework for the GNN, and/or the training database 130. For example, the input device(s) 160 enable the operator to update, intermittently and/or at predefined intervals, samples of the training database 130 for updating the GNN.

The output device(s) 170 of the illustrated example display information and/or data of the GNN, the framework for the GNN, and/or the training database 130, and/or the embeddings database 140. For example, the out device(s) 170 enable the operator to review, intermittently and/or at predefined intervals, entries within the training database 130 and/or the embeddings database 140 and/or instructions for the GNN and/or the framework. Examples of the output device(s) 170 include a display (e.g., a flat panel display, a liquid crystal display (LCD), an organic light emitting diode (OLED) display, etc.) and/or any other device that visually presents information to the operator. Additionally or alternatively, the output device(s) 170 may include one or more audio output devices (e.g., speakers) and/or haptic output device(s) for the operator.

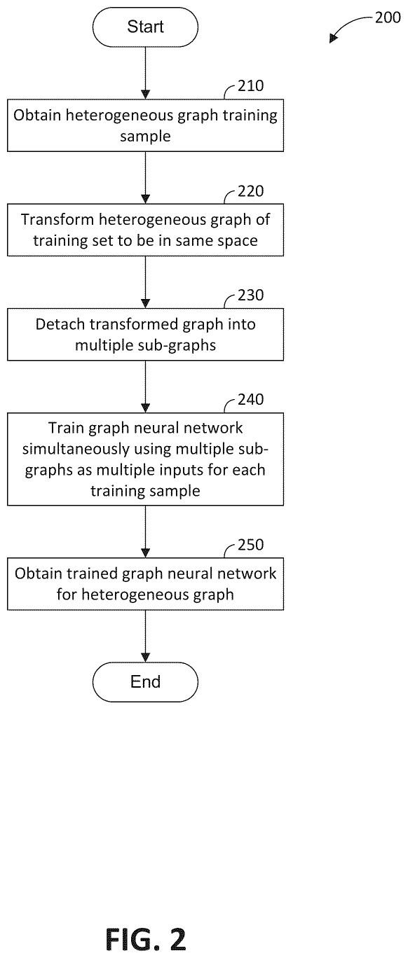

FIG. 2 is a flowchart of an example method 200 for using the example framework disclosed herein to train a GNN for a heterogeneous graph. The flowchart of FIG. 2 is representative of machine-readable instructions that are stored in memory (e.g., the memory 120 of FIG. 1) and include one or more programs which, when executed by one or more processors (e.g., the processor(s) 110 of FIG. 1), control operation of the system 100 to use the framework for training the GNN for the heterogeneous graph. While the example program is described with reference to the flowchart illustrated in FIG. 2, many other methods may alternatively be used. For example, the order of execution of the blocks may be rearranged, changed, eliminated, and/or combined to perform the method 200. Further, because the method 200 is disclosed in connection with the components of FIG. 1, some functions of those components will not be described in detail below.

Initially, at block 210, the processor(s) 110 obtaining a training sample. The training sample includes and/or is in the form of a heterogeneous graph with two or more node types with each node type represented in a different coordinate space. In some examples, the processor(s) 110 obtain the heterogeneous graph training sample from the training database 130. In other examples, to obtain the heterogeneous graph training sample, the processor(s) 110 generate the heterogeneous graph training sample based on data collected from the training database 130.

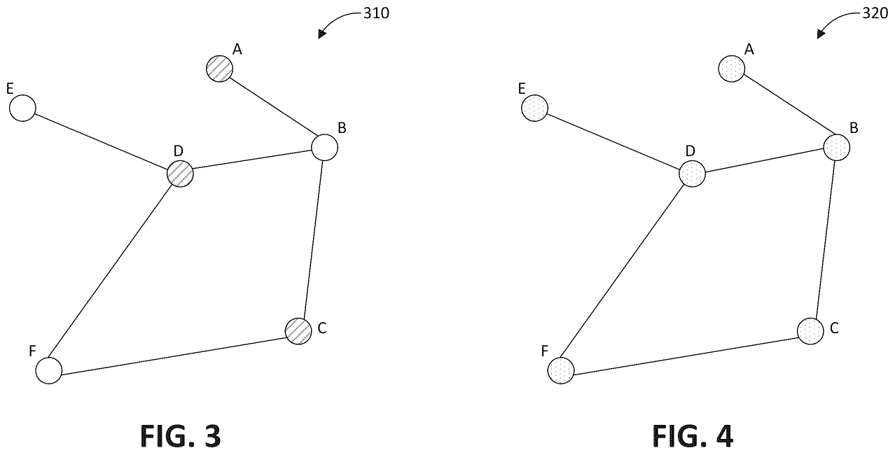

An example heterogeneous graph includes a node of a first node type, M, with k number of features and a node of second node type, N, with s number of features. In turn, the node of the first node type is represented with {M₁, M₂, M₃, . . . , Mₖ} and the node of the second node type is represented with {N₁, N₂, N₃, . . . , Nₛ}. Additionally, FIG. 3 depicts a portion of an example heterogeneous graph 310 with nodes A, C, and D being the first node type and nodes B, E, and F being the second node type. In the example provided above, the heterogeneous graph is a bipartite graph with two node types. In other examples, the heterogeneous graph includes more than two types of nodes.

At block 220, the processor(s) 110 transform the heterogeneous graph of the training sample into a homogeneous-like graph (also referred to as a “transformed graph”). The processor(s) 110 transform the heterogeneous graph such that all of the node types are represented in a shared coordinate space (as nodes in a homogeneous graph are). To transform the heterogeneous graph into the transformed graph, the processor(s) 110 normalize and merge the coordinate spaces of the node types together into the shared coordinate space.

For example, {M₁, M₂, M₃, . . . , Mₖ} for the first node type is transformed into {M₁, M₂, M₃, . . . , Mₖ, 0, 0, 0, . . . 0} with the number of 0s in the second portion equaling s, the number of features of the second node type. {N₁, N₂, N₃, . . . , Nₛ} for the second node type is transformed into {0, 0, 0, . . . 0, N₁, N₂, N₃, . . . , Nₛ} with the number of 0s in the first portion equaling k, the number of features of the first node type. Again, in the example provided above, the heterogeneous graph is a bipartite graph with two node types. In other examples, the heterogeneous graph includes more than two types of nodes such that the processor(s) 110 transforms more than two types of nodes together into a shared coordinate space.

FIG. 4 depict an example transformed graph 320 of a portion of the heterogeneous graph 310. As depicted in FIG. 4, the nodes A, C, and D of the first node type and the nodes B, E, and F of the second node type are transformed into the same coordinate space.

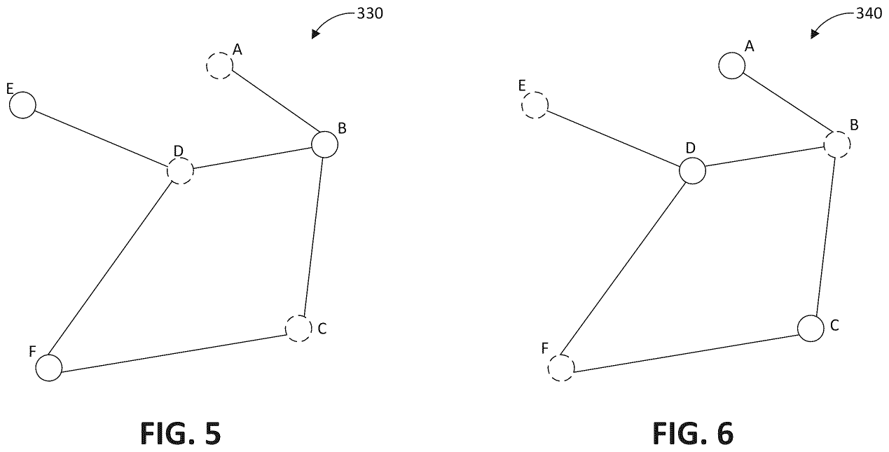

At block 230, the processor(s) 110 detach the transformed graph into multiple sub-graphs, with each sub-graph dedicated to a respective node type of the heterogeneous graph. That is, each sub-graph includes only one type of nodes while maintaining the graph structure of the heterogeneous graph. FIG. 5 depicts an example sub-graph 330 for the second type of nodes of the heterogeneous graph 310, and FIG. 6 depicts an example sub-graph 340 for the first type of nodes of the heterogeneous graph 310. The configuration of the sub-graphs enables a single heterogeneous GNN to be trained using the sub-graphs as multiple, simultaneous inputs.

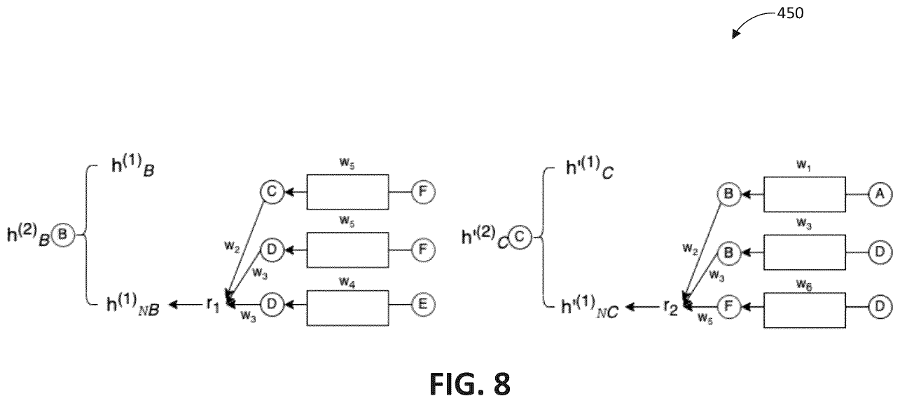

At block 240, the processor(s) 110 train and test the heterogeneous GNN using the pre-processed training sample. The processor(s) 110 simultaneously use all of the sub-graphs as multiple inputs for each training cycle or epoch. That is, the processor(s) 110 train and test the heterogeneous GNN and its parameters based on the information represented by all types of the sub-graphs (e.g., sub-graphs for a first node type, sub-graphs for a second node type, etc.). The processor(s) 110 conducting training on multiple and overlapping sub-graphs until the results converge on a stable result. In some examples, the processor(s) 110 use a weighted random walk algorithm and a double forward propagation algorithm to train the heterogeneous GNN with the multiple sub-graph inputs. FIG. 8 depicts a representation 450 of double forward propagations with a weighted random walk for training a heterogeneous GNN.

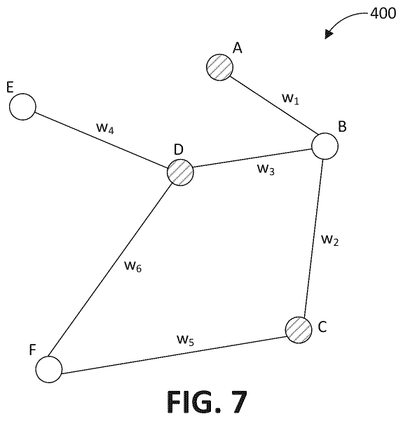

For example, the processor(s) 110 use the following inputs when performing the weighted random walk algorithm: the set of nodes M, which is a proper subset of V′; wᵢⱼ, which is a weight of an edge between nodes i and j; and target node n. FIG. 7 depicts a representation 400 of weights for edges between nodes for the heterogeneous graph 310. The processor(s) obtain S, which is a sampled set of neighborhood nodes for target node n, as an output. S is equal to argmax_{j∈M}w′ₙⱼ. To perform the weighted random walk algorithm, the processor(s) 110 start from target node n at time 0 and visit all of the neighborhood nodes of target node n in the depth of two edges. The weight of neighborhood node j for target node n is defined as w′ₙⱼ=K*wₙⱼ, where K is number of times a node is visited in a random walk.

The processor(s) 110, when performing double forward propagation algorithm, use multiple node types of a heterogeneous graph as an input and obtain a respective embedding system for each of the node types. The processor(s) 110 perform (1) a convolution of the first node type by updating each corresponding node embedding based on its neighborhood nodes and (2) a convolution of the second node type by updating each corresponding node embedding based on its neighborhood nodes. For example, the processor(s) 110 use multiple node types, M and N, as an input and obtain respective embedding systems, Ex and Ex, for those node types. The processor(s) 110 perform (1) a convolution of the M by updating each corresponding node embedding and (2) a convolution of N by updating each corresponding node embedding.

Again, in the example provided above, the heterogeneous graph is a bipartite graph with two node types, M and N, and two embedding systems, Ear and Ex. In other examples, the heterogeneous graph includes more than two types of nodes such that the processor(s) 110 obtain more than two embedding systems. In such examples, the processor(s) 110 perform a convolution for each node type by updating each corresponding node embedding.

At block 250, the processor(s) 110 obtain the trained heterogeneous GNN for subsequent use. For example, the processor(s) 110 may store code and/or other instructions for subsequently using the trained heterogeneous GNN in the memory 120 of the system 100. Upon training the heterogeneous GNN, the method 200 ends.

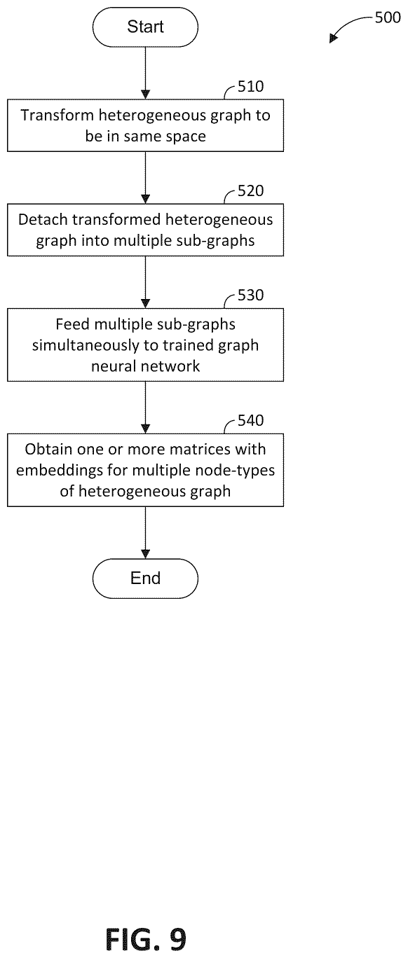

Turning to FIG. 9, a flowchart depicts an example method 500 for using the example framework disclosed herein to feed a heterogeneous graph to a trained GNN. The flowchart of FIG. 9 is representative of machine-readable instructions that are stored in memory (e.g., the memory 120 of FIG. 1) and include one or more programs which, when executed by one or more processors (e.g., the processor(s) 110 of FIG. 1), control operation of the system 100 to use the framework to feed the heterogeneous graph to the trained GNN. While the example program is described with reference to the flowchart illustrated in FIG. 9, many other methods may alternatively be used. For example, the order of execution of the blocks may be rearranged, changed, eliminated, and/or combined to perform the method 500. Further, because the method 500 is disclosed in connection with the components of FIGS. 1 and 3-6, some functions of those components will not be described in detail below.

Initially, at block 510, the processor(s) 110 transform a heterogeneous graph into a homogeneous-like graph. The processor(s) 110 transform the heterogeneous graph such that all of the node types are represented in a shared coordinate space (as nodes in a homogeneous graph are). To transform the heterogeneous graph into the transformed graph, the processor(s) 110 normalize and merge the coordinate spaces of the node types together into the shared coordinate space.

At block 520, the processor(s) 110 detach the transformed graph into multiple sub-graphs, with each sub-graph dedicated to a respective node type of the heterogeneous graph. That is, each sub-graph includes only one type of nodes while maintaining the graph structure of the heterogeneous graph. The pre-processing of the heterogeneous graph into the sub-graphs enables a single trained heterogeneous GNN to simultaneously provide multiple outputs (e.g., multiple embedding vectors, a matrix with multiple embedding rows or columns) based on multiple simultaneously-fed inputs (e.g., multiple sub-graphs). At block 530, the processor(s) 110 simultaneously feed the multiple sub-graphs to the trained heterogeneous GNN.

At block 540, the processor(s) 110 simultaneously obtain one more matrices from the trained heterogeneous GNN. The one more matrices include embeddings for the multiple node types of the heterogeneous graph. In some examples, the one more matrices are in the form of multiple embedding vectors, with each embedding vector corresponding to a respective one of the node types of the heterogeneous graph. In other examples, the one more matrices are in the form of a single matrix, with each row or column including embeddings for a respective one of the node types of the heterogeneous graph. Because all of the embedding matrices are produced simultaneously by the same trained heterogeneous GNN, all of the embedding matrices share the same coordinate space and belong to the same domain having the same physical meaning. In turn, the framework disclosed herein for training and using the heterogeneous GNN enables the processor(s) 110 to accurately perform cross-node similarity comparisons in a relatively efficient computational manner. Upon completion of block 540, the method 500 ends.

In a test, the results generated by the example framework used in the methods 200, 500 for a heterogeneous GNN compared favorably to PinSage, an existing bipartite GNN model. The test bipartite graph included more than 100,000 nodes, with 77,491 nodes representing a commercial product and 31,475 nodes representing a common keyword shared between products. Both types of nodes include multiple features, such as product title, product conversion rate, keyword search number, etc. Using the framework disclosed with respect to the methods 200, 500, recommended keywords, along with their importance, were calculated for each product by computing the text similarity between the embeddings of all of the nodes, both the product nodes and the keyword nodes, within the bipartite graph. These results were compared to those generated by the PinSage model. Table 1 is provided below, which shows a comparison of the average, as well as the weighted average, for both the Top 10 results and Top 5 results:

TABLE 1

| | |
|---|---|
| Top 10 | Top 5 |

| | Average | Weighted | Average | Weighted |
|---|---|---|---|---|
| Framework | 0.5103 | 0.5118 | 0.5306 | 0.5309 |
| PinSage | 0.4845 | 0.4861 | 0.5020 | 0.5024 |

As shown above, the framework disclosed herein significantly outperforms the PinSage model in every comparison category for generating keyword recommendations.

Alternatively, instead of obtaining one more embedding matrices from the trained heterogeneous GNN at block 540 for cross-node similarity comparisons, the processor(s) 110 may obtain one or more matrices from the trained heterogeneous GNN for cross-node clustering and classifications. That is, the framework for training and using the heterogeneous GNN also enables the processor(s) 110 to accurately perform cross-node clustering and classifications in a relatively efficient computational manner.

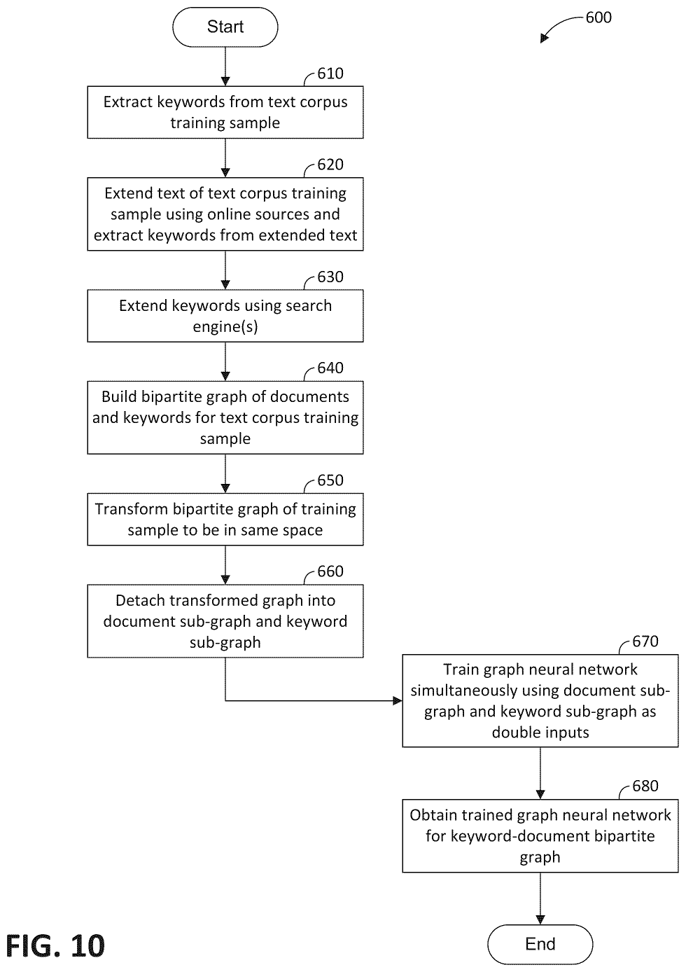

Turning to FIG. 10, a flowchart depicts an example method 600 for using the example framework disclosed herein to train a bipartite GNN for a keyword-document bipartite graph. The flowchart of FIG. 10 is representative of machine-readable instructions that are stored in memory (e.g., the memory 120 of FIG. 1) and include one or more programs which, when executed by one or more processors (e.g., the processor(s) 110 of FIG. 1), control operation of the system 100 to use the framework for training the bipartite GNN for the keyword-document bipartite graph. While the example program is described with reference to the flowchart illustrated in FIG. 10, many other methods may alternatively be used. For example, the order of execution of the blocks may be rearranged, changed, eliminated, and/or combined to perform the method 600. Further, because the method 600 is disclosed in connection with the components of FIG. 1, some functions of those components will not be described in detail below.

Initially, at block 610, the processor(s) 110 retrieve a training sample that is a text corpus from the training database 130 and extract keywords from documents of the text corpus. To extract keywords from the text corpus, the processor(s) 100 may use any algorithm (e.g., a fine-tuned BERT model) that is capable of (1) extracting keywords from a text corpus and (2) building a list of n-gram keywords for each document in the text corpus. Yake, which is an unsupervised, language-independent and corpus-independent approach to extract n-gram keywords, is an example algorithm that may be used to extract keywords from the documents of the text corpus.

At block 620, the processor(s) 110 extend text of one or more documents in the text corpus of the training sample and extract additional keywords from the extended text to extend the keyword pool. To extend the text of the text corpus, the processor(s) 110 use one or more of the keywords previously extracted from the text corpus at block 610 to query social media and/or search engine(s). Text that is obtained from the social media and/or search engine queries are used by the processor(s) 110 to extend the text of the text corpus. For example, the processor(s) 110 are configured to extend the text based on the top search results of a search engine using the previously-extracted keywords. By using social media to extend the text of the text corpus, the processor(s) 110 are able to extend topics included in the documents of the text corpus, regardless of whether such topics are conspicuous or inconspicuous in a document, due to social media being able to widely extend text related to keywords. Upon obtaining the extended text, the processor(s) 110 extract additional keywords from the text corpus use any capable keyword extraction algorithm (e.g., Yake).

At block 630, the processor(s) 110 extend the pool of keywords using one or more search engines (e.g., GOOGLE®). For example, to extend the pool of keywords, query search engine(s) using one or more of the keywords previously extracted from the text corpus at block 610. The processor(s) 110 use search engine(s) to extend the semantic coverage of keywords in a manner that reveals less conspicuous topics of a document. For example, the processor(s) 110 extend the pool of keywords by (1) obtaining the top search results of a search engine using the previously-extracted keywords and subsequently rerunning the keyword extraction algorithm on those search results and/or (2) obtaining suggested related keywords from the search engine.

At block 640, the processor(s) 110 build a keyword-document bipartite graph for the text corpus of the training sample. The processor(s) 110 builds the keyword-document bipartite graph to include two sets of nodes and edges that are linked together in the graph structure. One set of nodes represent the documents of the text corpus with each document node representing a different document of the text corpus. The other set of nodes represent keywords extracted for the text corpus with each keyword node representing a different extracted keyword. Each edge extends and represents a relationship between two of the nodes. Through commonly shared keyword node(s), different text documents are linked together within the structure of the keyword-document bipartite graph.

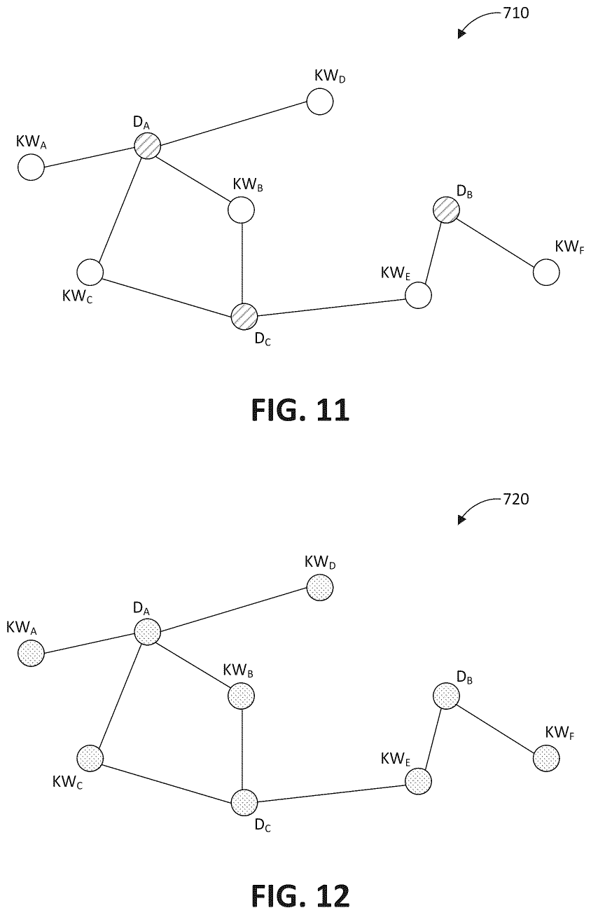

FIG. 11 depicts a portion of an example keyword-document bipartite graph 710. Each document node, D, has k number of features. Each keyword node, KW, has s number of features. In turn, each of the document nodes is represented with {D₁, D₂, D₃, . . . , Dₖ}, and each of the keyword nodes is represented with {KW₁, KW₂, KW₃, . . . , KWₛ}. All features of the document nodes and the keyword nodes participate in the training of a graph neural network to result in an accurate model. For example, nodes with similar features will be similarly trained for and embedded by an accurate graph neural network.

In the illustrated example, the processor(s) 110 build the bipartite graph of documents and keywords for the training sample based on (1) text within documents of the text corpus retrieved at block 610, (2) keywords extracted from the text corpus at block 620 (3) extended text identified at block 620, and (4) extended keywords identified at block 630. The extended text and keywords facilitate the processor(s) 110 in implementing a global approach for keyword recommendations in which (1) relationships between documents and (2) features of words in other documents of the text corpus are considered. In other examples, the processor(s) 110 build the keyword-document bipartite graph for the training sample without the extended text of block 620 and/or the extended keywords of block 630. That is, the method 600 may be executed without performing block 620 and/or block 630. In yet other examples, the keyword-document bipartite graph, not the text corpus itself, is stored and retrieved from the training database 130 such that the method 600 may be executed without performing blocks 610, 620, 630, 640.

At block 650, the processor(s) 110 transform the keyword-document bipartite graph 710 into a transformed graph 720 (also referred to as a “homogeneous-like graph”) of FIG. 12. The processor(s) 110 transform the keyword-document bipartite graph 710 such that both node types are represented in a shared coordinate space (as nodes in a homogeneous graph are). To transform the keyword-document bipartite graph 710 into the transformed graph 720, the processor(s) 110 normalize and merge the coordinate spaces of both node types together into the shared coordinate space.

For example, {D₁, D₂, D₃, . . . , Dₖ} for the document nodes is transformed into {D₁, D₂, D₃, . . . , Dₖ, 0, 0, 0, . . . 0} with the number of 0s in the second portion equaling s, the number of features of the keyword nodes. Additionally, {KW₁, KW₂, KW₃, . . . , KWₛ} for the keywords nodes is transformed into {0, 0, 0, . . . 0, KW₁, KW₂, KW₃, KWₛ} with the number of 0s in the first portion equaling k, the number of features of the document nodes. As depicted in FIG. 12, the document nodes and the nodes D_{A}, D_{B}, D_{C} and the keyword nodes KW_{A}, KW_{B}, KW_{C}, KW_{D}, KW_{E}, KW_{F} are transformed into the same coordinate space.

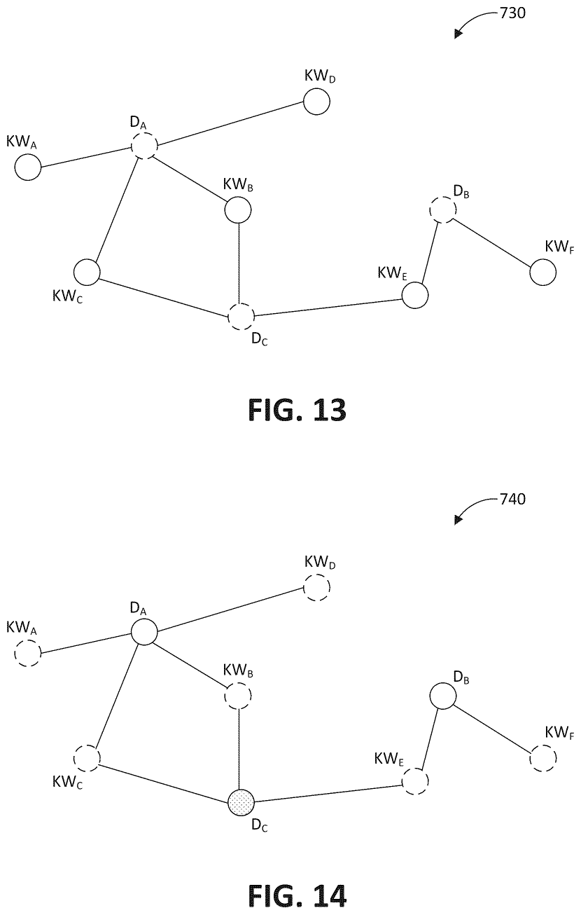

At block 660, the processor(s) 110 detach the transformed graph 720 into two sub-graphs. A keyword sub-graph 730 of FIG. 13 is dedicated to the keyword nodes of the keyword-document bipartite graph 710, and a document sub-graph 740 of FIG. 14 is dedicated to the document nodes of the keyword-document bipartite graph 710. While each of the sub-graphs 730, 740 includes only one node type, each of the sub-graphs 730, 740 maintains the graph structure of the keyword-document bipartite graph 710. The configuration of the sub-graphs 730, 740 enables a single bipartite GNN to be trained using the sub-graphs 730, 740 as multiple, simultaneous inputs.

At block 670, the processor(s) 110 train and test the bipartite GNN using the pre-processed training sample. The processor(s) 110 simultaneously use both the keyword sub-graph 730 and the document sub-graph 740 as double inputs for each training cycle or epoch. That is, the processor(s) 110 train and test the bipartite GNN and its parameters based on the information represented by both the keyword sub-graph 730 and the document sub-graph 740. In some examples, the processor(s) 110 use a weighted random walk algorithm and a double forward propagation algorithm, which are disclosed above in greater detail with respect to FIGS. 2 and 7-8, to train the bipartite GNN with the sub-graph inputs.

At block 680, the processor(s) 110 obtain the trained bipartite GNN for subsequent use. For example, the processor(s) 110 may store code and/or other instructions for subsequently using the trained bipartite GNN in the memory 120 of the system 100. Upon training the bipartite GNN for a keyword-document bipartite graph, the method 600 ends.

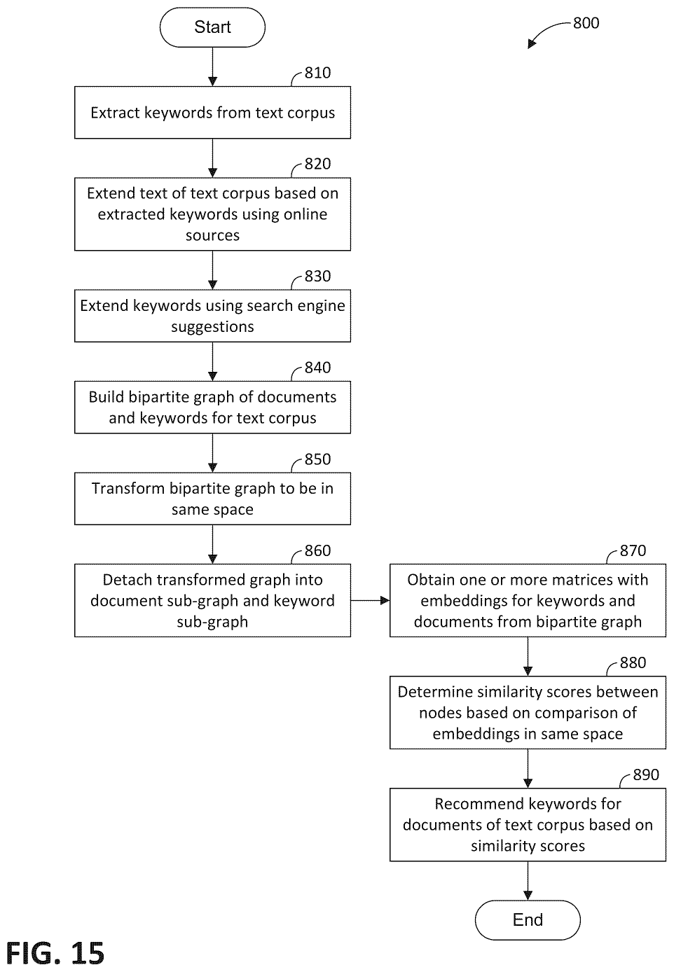

FIG. 15 is a flowchart of an example method 800 for using the example framework disclosed herein to feed a keyword-document graph to a trained GNN. The flowchart of FIG. 15 is representative of machine-readable instructions that are stored in memory (e.g., the memory 120 of FIG. 1) and include one or more programs which, when executed by one or more processors (e.g., the processor(s) 110 of FIG. 1), control operation of the system 100 to use the framework to feed the keyword-document graph to the trained GNN. While the example program is described with reference to the flowchart illustrated in FIG. 15, many other methods may alternatively be used. For example, the order of execution of the blocks may be rearranged, changed, eliminated, and/or combined to perform the method 800. Further, because the method 800 is disclosed in connection with the components of FIGS. 1 and 11-14, some functions of those components will not be described in detail below.

Initially, at block 810, the processor(s) 110 obtain a text corpus for which keywords are to be recommended and subsequently extract keywords from documents of the text corpus. To extract keywords from the text corpus, the processor(s) 100 may use any algorithm (e.g., Yake) that is capable of (1) extracting keywords from a text corpus and (2) building a list of n-gram keywords for each document in the text corpus.

At block 820, the processor(s) 110 extend text of one or more documents in the text corpus and extract additional keywords from the extended text to extend the keyword pool. For example, to extend the text of the text corpus, the processor(s) 110 use one or more of the keywords previously extracted from the text corpus at block 810 to query social media and/or search engine(s). Text that is obtained from the social media and/or search engine queries are used by the processor(s) 110 to extend the text of the text corpus. By using social media to extend the text of the text corpus, the processor(s) 110 are able to extend topics included in the documents of the text corpus, regardless of whether such topics are conspicuous or inconspicuous in a document, due to social media being able to widely extend text related to keywords. Upon obtaining the extended text, the processor(s) 110 extract additional keywords from the text corpus use any capable keyword extraction algorithm (e.g., Yake).

At block 830, the processor(s) 110 extend the pool of keywords using one or more search engines. For example, to extend the pool of keywords, query search engine(s) using one or more of the keywords previously extracted from the text corpus at block 810. The processor(s) 110 use search engine(s) to extend the semantic coverage of keywords in a manner that reveals less conspicuous topics of a document.

At block 840, the processor(s) 110 build a keyword-document bipartite graph for the text corpus. The processor(s) 110 builds the keyword-document bipartite graph to include two sets of nodes and edges that are linked together in the graph structure. One set of nodes represent the documents of the text corpus with each document node representing a different document of the text corpus. The other set of nodes represent keywords extracted for the text corpus with each keyword node representing a different extracted keyword. Each edge extends and represents a relationship between two of the nodes. Through commonly shared keyword node(s), different text documents are linked together within the structure of the keyword-document bipartite graph. In turn, the global structural relationship between the edges and the different types of nodes enables a keyword recommendation to be selected for a text document, not only when the corresponding keyword node being directly associated with the corresponding document node, but also when the corresponding keyword node is only indirectly associated with the corresponding document node.

In the illustrated example, the processor(s) 110 build the keyword-document bipartite graph based on (1) text within documents of the text corpus retrieved at block 810, (2) keywords extracted from the text corpus at block 820 (3) extended text identified at block 820, and (4) extended keywords identified at block 830. In other examples, the processor(s) 110 build the keyword-document bipartite graph for the training sample without the extended text of block 820 and/or the extended keywords of block 830. That is, the method 800 may be executed without performing block 820 and/or block 830.

At block 850, the processor(s) 110 transform the keyword-document bipartite graph into a transformed graph (also referred to as a “homogeneous-like graph”). The processor(s) 110 transform the keyword-document bipartite graph such that both node types are represented in a shared coordinate space (as nodes in a homogeneous graph are). To transform the keyword-document bipartite graph into the transformed graph, the processor(s) 110 normalize and merge the coordinate spaces of both node types together into the shared coordinate space.

At block 860, the processor(s) 110 detach the transformed graph 720 into two sub-graphs. A keyword sub-graph is dedicated to the keyword nodes of the keyword-document bipartite graph, and a document sub-graph is dedicated to the document nodes of the keyword-document bipartite graph. While each of the sub-graphs includes only one node type, each of the sub-graphs maintains the graph structure of the keyword-document bipartite graph. The configuration of the sub-graphs enables a single bipartite GNN to use the sub-graphs as multiple, simultaneous inputs.

At block 870, the processor(s) 110 simultaneously obtain one more matrices from the trained bipartite GNN. The one more matrices include embeddings for the document nodes and the keyword nodes of the bipartite graph. In some examples, the one more matrices are in the form of multiple embedding vectors, with each embedding vector corresponding to a respective node type. For example, the processor(s) 110 obtain a document embedding vector and a keyword embedding vector from the bipartite GNN. In other examples, the one more matrices are in the form of a single matrix, with each row or column including embeddings for a respective node type. For example, one row or column corresponds with the document nodes, and another row or column corresponds with the keyword nodes. Because all of the embedding matrices are produced simultaneously by the same bipartite GNN, all of the embedding matrices share the same coordinate space and belong to the same domain having the same physical meaning. In turn, the framework disclosed herein for training and using the heterogeneous GNN enables the processor(s) 110 to accurately perform cross-node similarity comparisons in a relatively efficient computational manner.

At block 880, the processor(s) 110 determine similarity scores between the nodes based on a comparison of the embeddings in the shared coordinate space that were obtained from the bipartite GNN. That is, the processor(s) 110 compute similarity scores between documents represented by the document nodes and keywords represented by the keyword nodes. Because the embeddings are in the same coordinate space, a document node and a keyword node can be compared directly with each other. In some examples, the similarity scores are calculated using cosine similarities.

At block 890, the processor(s) 110 generate keyword recommendations for the documents of the test corpus based on the similarity scores. For example, for each document in the test corpus, the processor(s) 110 rank potential keyword recommendations based on corresponding similarity scores between those keywords and the document. The processor(s) 110 select up to a predefined number of keywords that have the greatest similarity scores.

In a test, the results generated by the globalized approach of the example framework used in the methods 600, 800 compared favorably to a combination of Yake and Keybert, which are existing models used to extract keywords from documents and return the top n keywords in a localized approach based on the frequency of those keywords.

To evaluate a model's keyword extraction performance, traditional evaluation metrics, such as precision, recall, F1, and mean average precision, are oftentimes used. However, such metrics are less meaningful when measuring the extraction of keywords globally, where keywords are selected not only based on whether documents contain a particular keyword but also based on (1) relationships between documents and (2) features of words in other documents of the text corpus are considered.

To compare the results generated by the example framework used in the methods 600, 800 to a combination of the Yake and Keybert models, an evaluation metric was developed in which product webpages (Amazon® product webpages) of review data (e.g., Amazon® review data) are collected for a document dataset. For example, Amazon® review data includes product information, such as title, description, bullets, product review, etc. Each product page of the review data is regarded as a text document of a text corpus.

To conduct the comparison between the framework disclosed herein and the Yake and Keybert combination, tests for multiple product categories were conducted. Table 2 is provided below, which shows a comparison between the framework disclosed herein and the Yake and Keybert combination for the Top 10 results for various product categories.

TABLE 2

| Keyword | Framework | Yake & Keybert |
|---|---|---|
| Dollhouses | 0.3351169 | 0.2169679 |
| Toothpastes | 0.34412223 | 0.24297814 |
| TV | 0.47058615 | 0.2287269 |
| Coffee | 0.36931056 | 0.18826456 |
| Diffusers | 0.39545947 | 0.3796089 |
| Monitors | 0.42884916 | 0.32018107 |
| Candy and Chocolate | 0.33688563 | 0.16572496 |
| Bars | | |
| Popcorn | 0.32148868 | 0.16572496 |

Table 3 is provided below, which shows a comparison between the framework disclosed herein and the Yake and Keybert combination for the Top 20 results for various product categories.

TABLE 3

| Keyword | Framework | Yake & Keybert |
|---|---|---|
| Dollhouses | 0.33953336 | 0.19725615 |
| Toothpastes | 0.28394723 | 0.2630458 |
| TV | 0.45218357 | 0.27218032 |
| Coffee | 0.33277428 | 0.17184108 |
| Diffusers | 0.3552942 | 0.34463617 |
| Monitors | 0.4095853 | 0.31529266 |
| Candy and Chocolate | 0.3115395 | 0.27812457 |
| Bars | | |
| Popcorn | 0.30053043 | 0.16459098 |

As shown above in Tables 2 and 3, the framework disclosed herein significantly outperforms the Yake and Keybert combination for every product category for both the Top 10 and Top 20 keyword recommendations.

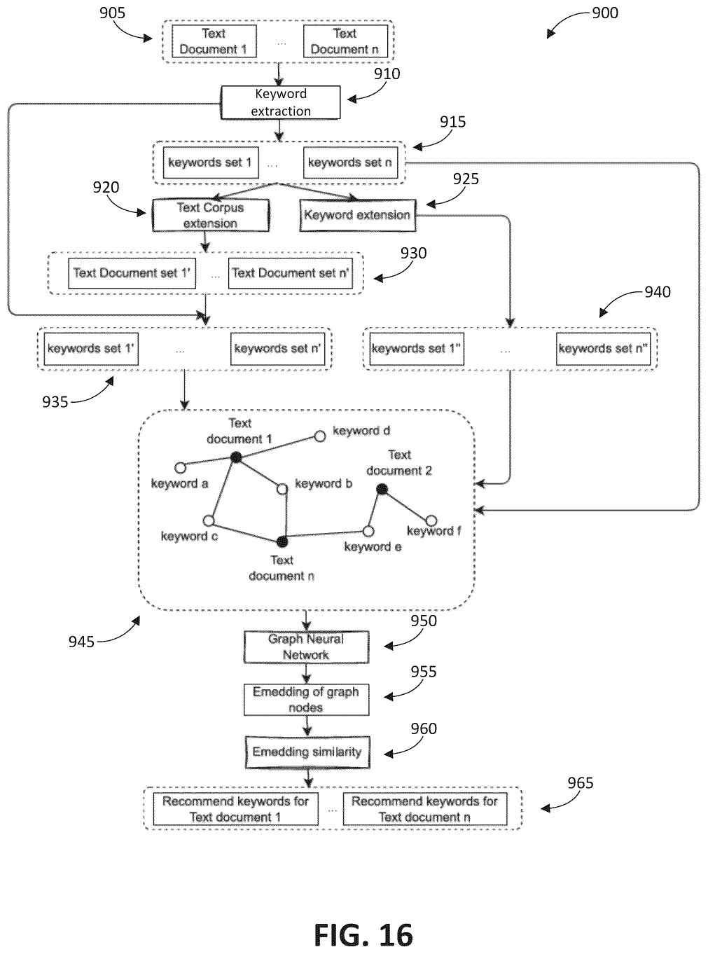

FIG. 16 further depicts a process 900 of using the example framework disclosed herein to generate keyword recommendations for a text corpus using a trained bipartite GNN. Initially, the processor(s) 110 obtain a text corpus 905. The processor(s) 110 then perform a keyword extraction algorithm 910 (e.g., Yake) to extract keywords from the text corpus 905 and build a keyword pool 915 that includes a list of keywords for each document in the text corpus.

Upon building the keyword pool 915 for the text corpus 905, the processor(s) 110 perform a text-extension operation 920 and a keyword-extension operation 925. The processor(s) 110 perform the text-extension operation 920 to (1) obtain text extension documents 930 for the text corpus 905 using social media and/or search engine(s) and (2) subsequently obtain keyword extensions 935 using a keyword extraction algorithm (e.g., the keyword extraction algorithm 910) for the keyword pool 915. The processor(s) 110 perform the keyword-extension operation 925 using search engine(s) and a keyword extraction algorithm (e.g., the keyword extraction algorithm 910) to obtain additional keyword extensions 940.

The processor(s) 110 then build a keyword-document bipartite graph 945 using (1) the documents of the text corpus 905 and the text extension documents 930 and (2) the keywords of the keyword pool 915, the keyword extensions 935, and the keyword extensions 940. Upon building the keyword-document bipartite graph 945, the processor(s) 110 feed the keyword-document bipartite graph 945 to a trained bipartite GNN 950 and obtain node embeddings 955 from the trained bipartite GNN 950. In turn, the processor(s) 110 obtain similarity scores 960 for the node embeddings 955 and generate keyword recommendations 965 for each of the documents within the text corpus 905 based on the similarity scores 960.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A system for providing keyword recommendations for a text corpus, the system comprising:
memory configured to store a graph neural network that is trained to embed multiple node types of a heterogeneous graph in a shared coordinate space; and
one or more processors configured to:
obtain the text corpus that includes documents;
generate keywords for the text corpus, at least in part, by extracting extracted keywords from the documents;
build the heterogeneous graph to include nodes and edges, wherein the nodes include document nodes each of which represents a respective one of the documents in a first coordinate space associated with document features, wherein the nodes include keyword nodes each of which represents a respective one of the keywords in a second coordinate space associated with keyword features, wherein the edges extend between the nodes to represent relationships between the documents and the keywords;
transform the heterogeneous graph into a transformed graph in which the document nodes and the keyword nodes are in the shared coordinate space;
separate the transformed graph into a first transformed sub-graph that includes the document nodes without the keyword nodes in the shared coordinate space and a second transformed sub-graph that includes the keyword nodes without the document nodes in the shared coordinate space;
feed the first transformed sub-graph and the second transformed sub-graph to the graph neural network;
obtain one or more embedding matrices from the graph neural network that include document embeddings for the document nodes and keyword embeddings for the keyword nodes in the shared coordinate space to enable the document embeddings and the keyword embeddings to be compared directly to each other;
determine similarity scores among the nodes based on comparisons between the document embeddings and the keyword embeddings; and
generate the keyword recommendations for the text corpus based on the similarity scores.

2. The system of claim 1, wherein to transform the heterogeneous graph into the transformed graph, the one or more processors are configured to normalize and merge together a first matrix representing the document nodes and a second matrix representing the document nodes in the shared coordinate space.

3. The system of claim 1, wherein the one or more processors are configured to feed the first transformed sub-graph and the second transformed sub-graph to the graph neural network simultaneously as separate inputs.

4. The system of claim 1, wherein the one or more processors are configured to determine the similarity scores using cosine similarity.

5. The system of claim 1, further comprising an embeddings database in which the one or more processors are configured to store the similarity scores for the documents and the keywords of the text corpus.

6. The system of claim 1, wherein, to generate the keyword recommendations for the text corpus, the one or more processors are configured to select one or more of the keywords for each of the documents in the text corpus.

7. The system of claim 1, wherein, to generate the keyword recommendations for the text corpus, the one or more processors are configured to select up to a predefined number of greatest-scoring keywords.

8. The system of claim 1, wherein the keywords include the extracted keywords and extended keywords, and wherein, to generate the keywords for the text corpus, the one or more processors are further configured to:
collect extended text for the text corpus by querying at least one of a social media or a search engine using the extracted keywords; and
extract the extended keywords from the extended text.

9. The system of claim 1, wherein the keywords include the extracted keywords and extended keywords, and wherein, to generate the keywords for the text corpus, the one or more processors are further configured to collect the extended keywords by using a search engine to query for additional keyword suggestions for the extracted keywords.

10. The system of claim 1, further comprising a training database that is configured to store a training sample, and wherein the one or more processors are configured to train the graph neural network using the training sample.

11. The system of claim 10, wherein the training sample is a heterogeneous graph sample, and wherein the one or more processors are configured transform the heterogeneous graph sample into a transformed training graph and separate the transformed training graph into a first training sub-graph and a second training sub-graph.

12. The system of claim 1, wherein, to train the graph neural network, the one or more processors are configured to use weighted random walk and double forward propagations.

13. A method for providing keyword recommendations for a text corpus, the method comprising:
obtaining, via one or more processors, the text corpus that includes documents;
generating, via the one or more processors, keywords for the text corpus, at least in part, by extracting extracted keywords from the documents;
building, via the one or more processors, a heterogeneous graph to include nodes and edges, wherein the nodes include document nodes each of which represents a respective one of the documents in a first coordinate space associated with document features, wherein the nodes include keyword nodes each of which represents a respective one of the keywords in a second coordinate space associated with keyword features, wherein the edges extend between the nodes to represent relationships between the documents and the keywords;
transforming, via the one or more processors, the heterogeneous graph into a transformed graph in which the document nodes and the keyword nodes are in a shared coordinate space;
separating, via the one or more processors, the transformed graph into a first transformed sub-graph that includes the document nodes without the keyword nodes in the shared coordinate space and a second transformed sub-graph that includes the keyword nodes without the document nodes in the shared coordinate space;
feeding, via the one or more processors, the first transformed sub-graph and the second transformed sub-graph to a graph neural network that is trained to embed multiple node types of the heterogeneous graph in the shared coordinate space;
obtaining, via the one or more processors, one or more embedding matrices from the graph neural network that include document embeddings for the document nodes and keyword embeddings for the keyword nodes in the shared coordinate space to enable the document embeddings and the keyword embeddings to be compared directly to each other;
determining, via the one or more processors, similarity scores among the nodes based on comparisons between the document embeddings and the keyword embeddings; and
generating, via the one or more processors, the keyword recommendations for the text corpus based on the similarity scores.

14. The method of claim 13, further comprising training the graph neural network using a training sample stored in a training database.

15. The method of claim 13, wherein generating the keywords for the text corpus further includes:
identifying first extended keywords by:
collecting extended text for the text corpus by querying at least one of a social media or a search engine using the extracted keywords; and
extracting the first extended keywords from the extended text; and
identifying second extended keywords by using a search engine to query for additional keyword suggestions for the extracted keywords.

16. A computer readable medium including instructions, which, when executed, cause a machine to:
obtain a text corpus that includes documents;
generate keywords for the text corpus, at least in part, by extracting extracted keywords from the documents;
build a heterogeneous graph to include nodes and edges, wherein the nodes include document nodes each of which represents a respective one of the documents in a first coordinate space associated with document features, wherein the nodes include keyword nodes each of which represents a respective one of the keywords in a second coordinate space associated with keyword features, wherein the edges extend between the nodes to represent relationships between the documents and the keywords;
transform the heterogeneous graph into a transformed graph in which the document nodes and the keyword nodes are in a shared coordinate space;
separate the transformed graph into a first transformed sub-graph that includes the document nodes without the keyword nodes in the shared coordinate space and a second transformed sub-graph that includes the keyword nodes without the document nodes in the shared coordinate space;
feed the first transformed sub-graph and the second transformed sub-graph to a graph neural network that is trained to embed multiple node types of the heterogeneous graph in the shared coordinate space;
obtain an embedding matrices from the graph neural network that include document embeddings for the document nodes and keyword embeddings for the keyword nodes in the shared coordinate space to enable the document embeddings and the keyword embeddings to be compared directly to each other;
determine similarity scores among the nodes based on comparisons between the document embeddings and the keyword embeddings; and
generate keyword recommendations for the text corpus based on the similarity scores.

17. The computer readable medium of claim 16, wherein the instructions further cause the machine to train the graph neural network using a training sample stored in a training database, wherein the training sample is a heterogeneous graph sample.

18. The computer readable medium of claim 17, wherein the instructions further cause the machine to transform the heterogeneous graph sample into a transformed training graph and separate the transformed training graph into a first training sub-graph and a second training sub-graph.

19. The computer readable medium of claim 16, wherein, to train the graph neural network, the instructions further cause the machine to use weighted random walk and double forward propagations.

20. The computer readable medium of claim 16, wherein, to generate the keywords for the text corpus, the instructions further cause the machine to identify first extended keywords and second extended keywords,
wherein, to identify the first extended keywords, the instructions further cause the machine to collect extended text for the text corpus by querying at least one of a social media or a search engine using the extracted keywords and extract the first extended keywords from the extended text, and
wherein, to identify the second extended keywords, the instructions further cause the machine to use a search engine to query for additional keyword suggestions for the extracted keywords.
